(19) United States
(12) Patent Application Publication
(10) Pub. No.: US 2007/0200276 A1
(43) Pub. Date: Aug. 30, 2007

(54) Method for rapid printing of near-field and imprint lithographic features

(75) Inventors: Jeff Mackey, Boise, ID (US); Gurtej Sandhu, Boise, ID (US)

Correspondence Address: WHYTE HIRSCHBOECK DUDEK S.C., 555 EAST WELLS STREET, SUITE 1900, MILWAUKEE, WI, 53202, US

(73) Assignee: Micron Technology, Inc., Boise, ID (US)

(21) Appl. No.: 11/362,325

(22) Filed: Feb. 24, 2006

(51) Int. Cl. B29C 59/02

(52) U.S. Cl. 264/293; 264/494; 264/320; 425/385; 425/174.4; 101/368; 101/483

(57) ABSTRACT

An apparatus, systems, and methods to print multiple fields on a substrate in parallel are provided. The apparatus incorporates a lithographic apparatus composed of two or more lithographic heads coupled to a common housing as a unit, with each head configured to hold a patterned template. Software can be utilized to keep track of what is printed at any given step, and conventional servometers can be used to reposition the head unit and templates in multiple steps to print the remainder of a wafer.

### FIELD OF THE INVENTION

The invention relates generally to material processing systems, and more particularly to lithography systems.

### BACKGROUND OF THE INVENTION

Lithography is a key process in the fabrication of semiconductor integrated circuits. Photolithography typically involves projecting an image through a reticle or mask onto a thin film of photoresist or other material that covers a semiconductor wafer or other substrate, and developing the film to remove exposed or unexposed portion s of the resist to produce a pattern in subsequent processing steps.

In semiconductor processing, the continual shrink in feature sizes requires systems to produce smaller features. However, with conventional photolithography using light, the minimum feature size and spacing between patterns is generally on the order of the wavelength of the radiation used to expose the film layer. This limits the ability to produce extremely small structural features for integrated circuits. Consequently, lithography systems have turned away from visible light and new processes have been developed. Among those methods are imprint lithography and near-field optical lithography, which can be used to create features of 100 nm and less.

Imprint lithography involves stamping or pressing a template having small scale features into a thin polymeric film to form a relief pattern that is then processed (e.g., by etching) to expose substrate regions. Near-field optical lithography is a technique in which light (either visible or ultraviolet (UV)) is irradiated through a template (photomask, reticle) that is positioned in close proximity to a resist film on the substrate such that the distance is small enough (typically 100 nm or less) during light exposure, such that diffraction occurs in the Fresnel limit (as opposed to the Fraunhoffer limit), in which electric and magnetic responses of materials are decoupled.

More recently, high-density nanolithography techniques have been developed using surface plasmons (SPs) to manipulate the exposure light into a sub-wavelength. The technique utilizes transmission of light (e.g., UV light) through sub-wavelength hole arrays on an opaque metal film to excite SPs on the metal film surface and enhance transmission to provide features of 90 nm and less.

With current imprint and sub-wavelength printing technologies, it is not possible to print an entire wafer at once due to alignment and overlay (registration) problems and image distortion associated with full-size masks and printing a large area.

To overcome such problems, a “step and repeat” process is typically conducted using a stepper apparatus in which a template that is smaller than the total surface area of the substrate is used to imprint a pattern onto a defined portion of the substrate (i.e., “field”) during any given step. The size of the field processed during each step should be small enough to limit pattern distortions and achieve low critical dimension (CD) variations. During a typical step and repeat process, the template is aligned with marks provided on the substrate, for example, using an optical alignment device, and the template pattern is imprinted on the film layer. The template is then moved to a new field location, aligned, and the surface imprinted. This process may be continually repeated until the substrate is patterned.

Imprint and near-field lithography techniques are very promising but have many problems that must overcome before they present a viable challenge to conventional lithography. One problem is that present imprint and near-field lithography apparatus provide single field imprinting in any one step.

Another problem concerns registration, which refers to the matching of the current printing level on the substrate with the underlying level. Accurate alignment of the patterned layer with previously formed layers on the substrate ensures that the circuit components are correctly positioned relative to each other for the device to function properly. Proper registration must not only insure that features are in the appropriate position with respect to the prior level, but also that any distortions are matched as well. In conventional photolithography, this is handled through the use of projection optics.

To correct registration in imprint or near-field optical lithography, distortion is introduced into the template itself, typically by applying a mechanical forced onto the edges of the template. This requires that the template be adjusted at each Field prior to printing, which lowers processing throughput.

It is important for lithography equipment to possess sufficiently high throughput in order to reduce overall processing time and production costs. Therefore, it would be desirable to provide an apparatus and method that facilitates rapid printing and increased processing throughput.

### SUMMARY OF THE INVENTION

The present invention is directed to lithographic systems for forming a pattern on a substrate that incorporates a lithographic head apparatus composed of two or more lithographic heads coupled to a common housing as a unit, with each head configured to hold a patterned template, and lithographic methods for forming a pattern on a substrate having a plurality of defined fields utilizing the lithographic head apparatus.

In one aspect, the invention provides a lithographic system for forming patterns on a substrate. The system includes components configured to position two or more patterned templates in proximity to the substrate for patterning a plurality of fields on the substrate in parallel. In general, the system includes a template positioning system comprising a housing coupled to a plurality of lithographic heads, each head configured to hold a patterned template. Each head is preferably constructed as a stand-alone device, combined with other lithographic heads within the housing to form a single unit for processing a number of fields on a substrate in parallel or about concurrently. Each of the heads is connected to a system controller, which coordinates movements of each head to align the attached template with a particular field to be imprinted on the substrate.

In one embodiment, the lithographic heads and templates are configured for imprint lithography processing. In another embodiment, the lithographic heads and templates are configured for near-field optical lithography processing. In an embodiment of a near-field system, the templates are configured to include a metal layer for generating surface plasmons.

Each head preferably includes an alignment device coupled thereto, which is operable for aligning the template to the substrate, for example, an optical alignment device that includes a sensor (e.g., a fiber optic sensor). Each head can further include an actuator mechanism coupled thereto, which is configured to move the head in an X-Y plane, a Z-plane, or both. Each head can also include a mechanism structured for altering the orientation of the template to the surface to adjust distortion.

In another embodiment of a lithographic system according to the invention, the system can include a template positioning system according to the invention, a wafer stage configured to support the substrate and move the substrate in a an X-Y plane and/or a Z-plane, and a system controller coupled to and configured for actuating the template positioning system, alignment system, and wafer stage, to position the templates in parallel in proximity to the substrate. The system can further include a liquid dispenser configured to dispense a curable liquid onto the substrate situated on the wafer stage.

In another aspect, the invention provides lithographic methods for forming a pattern on a substrate having a plurality of defined fields. In one embodiment, the method includes aligning a template positioning system of the invention relative to the substrate such that each template is aligned within a different field on the substrate; and patterning each of the fields underlying the templates in parallel or about concurrently. The method can further include activating one or more alignment devices that are coupled to each head to align the templates within each of said fields. In addition, the method can include actuating one or more actuator mechanisms that are coupled to each head to move the head coupled thereto in an X-Y plane and/or a Z-plane. The method can also include actuating one or more of template-adjusting mechanisms coupled to each head to alter an orientation of the template coupled thereto to the substrate.

In a system comprising an imprint template, the patterning step can include contacting the substrate with each of said templates to pattern the plurality of fields about concurrently. In a system for near-field lithography in which each head includes a radiation illuminating system (e.g., light source, collimating lens, etc.), the patterning step can include activating the radiation illuminating systems of each of the heads to generate radiation through each of the photomask templates to pattern the plurality of fields about concurrently.

In another embodiment, the method of patterning a plurality of defined fields on a substrate can include providing an apparatus that having a template positioning system according to the invention, a wafer stage configured to support the substrate and move the substrate in an X-Y plane and/or a Z-plane, and a system controller coupled to and configured for actuating the template positioning system, alignment system, and wafer stage, to position the templates in parallel in proximity to the substrate; moving the wafer stage to align the substrate relative to the templates such that each template is aligned within a different field of said plurality of fields on the substrate; and patterning the plurality of fields about concurrently utilizing the templates in parallel. Where the apparatus includes a liquid dispenser, the method can further include dispensing a curable liquid to form the substrate layer over a supporting substrate (e.g., semiconductor wafer) prior to the patterning step. Additional process steps can include moving the wafer stage to realign the substrate relative to the template positioning system such that the templates are aligned with a non-patterned set of fields on the substrate, and each template is aligned within a different field of said plurality of fields, and then patterning the second set of fields about concurrently utilizing each of said templates in parallel, and further repeating those steps to complete patterning of the substrate.

In yet another aspect, the invention provides a lithographic apparatus. In one embodiment, the lithographic apparatus comprises two or more lithographic heads coupled to a common housing as a unit, each head configured to hold a patterned template. Each head can include a device coupled thereto such as an actuator device configured to move the head in an X-Y plane and/or a Z-plane, a device operable for aligning the template to a substrate, and/or a device operable to alter the orientation of the template to the substrate for adjusting template distortion. In embodiments of the lithographic apparatus, the heads and the templates can be configured for imprint lithography, or for near-field optical lithography with components for generating radiation, including a template structured for generating surface plasmons.

Using the present system, two or more heads, each with its own template can be used simultaneously on a single wafer or other substrate. The present apparatus and methods for printing multiple fields on a substrate in parallel advantageously provide increased throughput by a factor of two or more, according to the number of imprint heads that are employed within a processing unit. For example, in the use of processing unit constructed with four imprint heads, a wafer can be processed about four times faster than is achieved by a conventional step-and-repeat single field imprint process. The use of multiple heads provides an intermediate approach between one-shot printing of an entire wafer surface and printing one field of a wafer at a time. The present apparatus provides very high throughput by large area coverage, while retaining high resolution to assure layer-to-layer alignment, to reduce overall processing time and production costs.

### BRIEF DESCRIPTION OF THE DRAWINGS

Preferred embodiments of the invention are described below with reference to the following accompanying drawings, which are for illustrative purposes only. Throughout the following views, the reference numerals will be used in the drawings, and the same reference numerals will be used throughout the several views and in the description to indicate same or like parts.

FIGS. 1-2 are diagrammatic, elevational, cross-sectional views of an embodiment of a system according to the invention for imprint lithography, at sequential processing stages.

FIG. 3 is a top view of the system of FIG. 1, including a cross-section of FIG. 1 along line 1-1.

FIG. 4 is a diagrammatic, isometric view of the system shown in FIG. 2.

FIGS. 5-6 are diagrammatic, elevational, cross-sectional views of another embodiment of a system according to the invention for near-light optical lithography, at sequential processing stages.

FIG. 7 is a block diagram of an embodiment of a system according to the invention utilizing multiple stages to imprint a wafer.

FIG. 8 is a block diagram of an embodiment of an electronic system incorporating a device processed according to the invention.

### DETAILED DESCRIPTION OF THE INVENTION

The following description with reference to the figures provides illustrative examples of lithography systems for processing multiple locations (fields) on a substrate in parallel. Such description is only for illustrative purposes and it is to be understood that the invention can have application to other apparatus, processes, and technologies. Thus, the present invention is not limited to the described illustrative examples.

For the convenience of drawings and explanation, the lithographic head unit is shown as having four heads. Other configurations such as a unit having two heads, three heads, or more than four heads, are within the scope of the invention.

In the context of the current application, the term “semiconductor substrate” or “semiconductive substrate” or “semiconductive wafer fragment” or “wafer fragment” or “wafer” will be understood to mean any construction comprising semiconductor material, including but not limited to bulk semiconductive materials such as a semiconductor wafer (either alone or in assemblies comprising other materials thereon), and semiconductive material layers (either alone or in assemblies comprising other materials). The term “substrate” refers to any supporting structure including, but not limited to, the semiconductive substrates, wafer fragments or wafers described above.

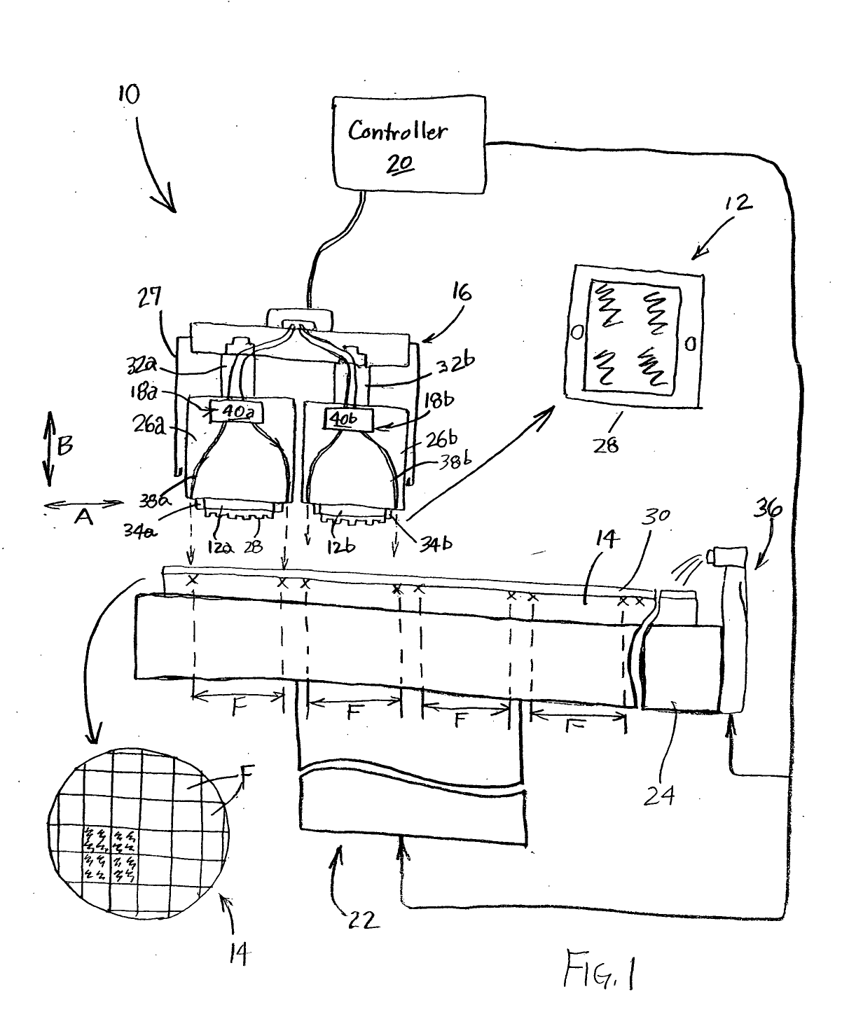

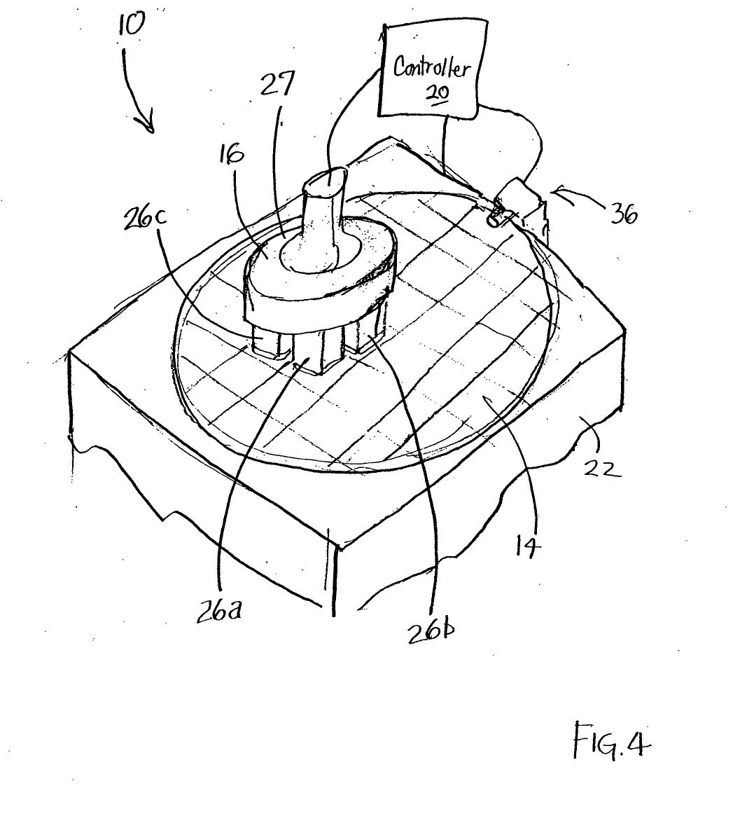

FIGS. 1-4 depict an embodiment of a system 10 according to the invention for imprint lithography, which includes elements for aligning a plurality of patterned templates 12 with respect to a substrate 14 to be processed, which is a wafer in the present example.

The system 10 generally includes a template positioning system 16, an alignment system 18, a system controller 20, and a wafer stage 22.

The wafer 14 to be imprinted is mounted onto a support 24 (e.g., wafer chuck) of a wafer stage 22, which is moveable in the illustrated embodiment in a generally planar (horizontal) X-Y axis. Such moveable stages are known and commercially available. The wafer can be secured to the support 24, for example, by means of a vacuum system, which applies a vacuum to the wafer 14 to pull the wafer against the support and maintain the wafer in a fixed position on the support, or by means of a mechanical claim, among other techniques. During use, the movable stage 22, the position of the wafer 14 is incrementally advanced by “stepping” or moving the stage 22 supporting the wafer. The wafer stage 22 can include mechanisms that can perform various wafer position adjustments, including, for example, rotating the wafer support to correct an error from the prealigner, raising or lowering the wafer relative to the templates, tilt adjustments to provide wafer leveling, etc. In another embodiment, the wafer stage 22 can remains in a fixed position while the heads 26a-d are varied to access different parts of the wafer.

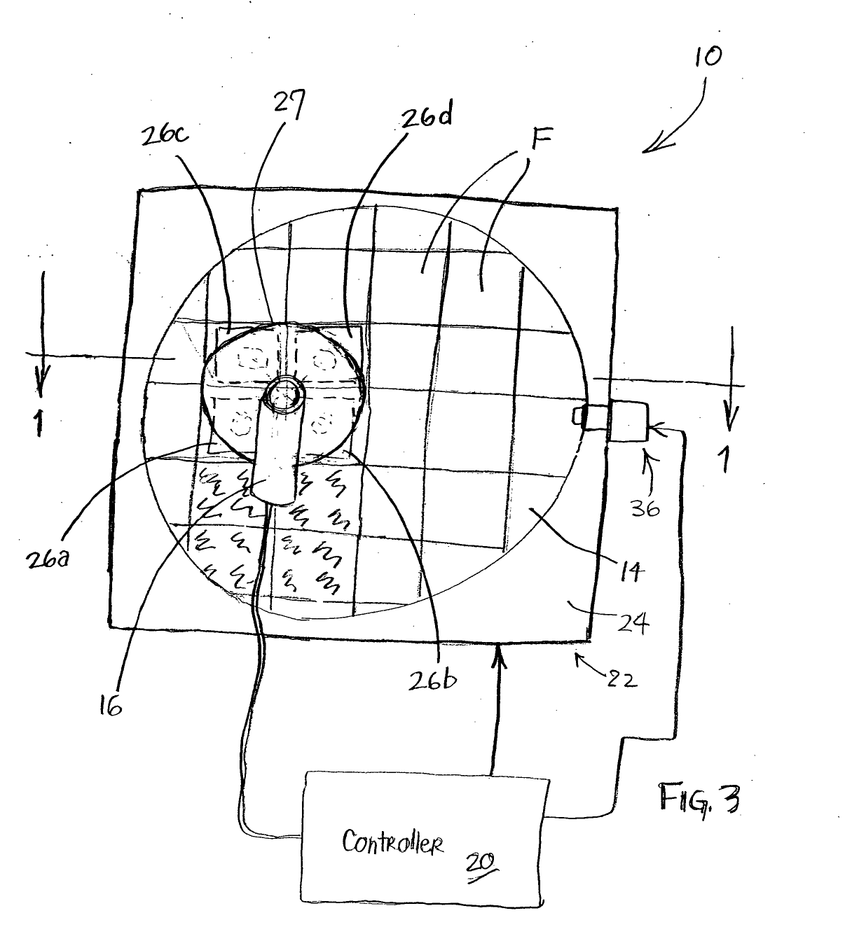

The template positioning system 16 includes a plurality of heads shown as four heads 26a-d (FIG. 3) in the present embodiment. Theoretically, the number of heads that are provided within a single unit is limited based on the real estate required for alignment and positioning devices on each head. The multiple head unit is constructed to provide adequate real estate (i.e., spacing) in the vicinity of each head to allow for registration correction, while delivering a throughput multiplication by printing several areas at once.

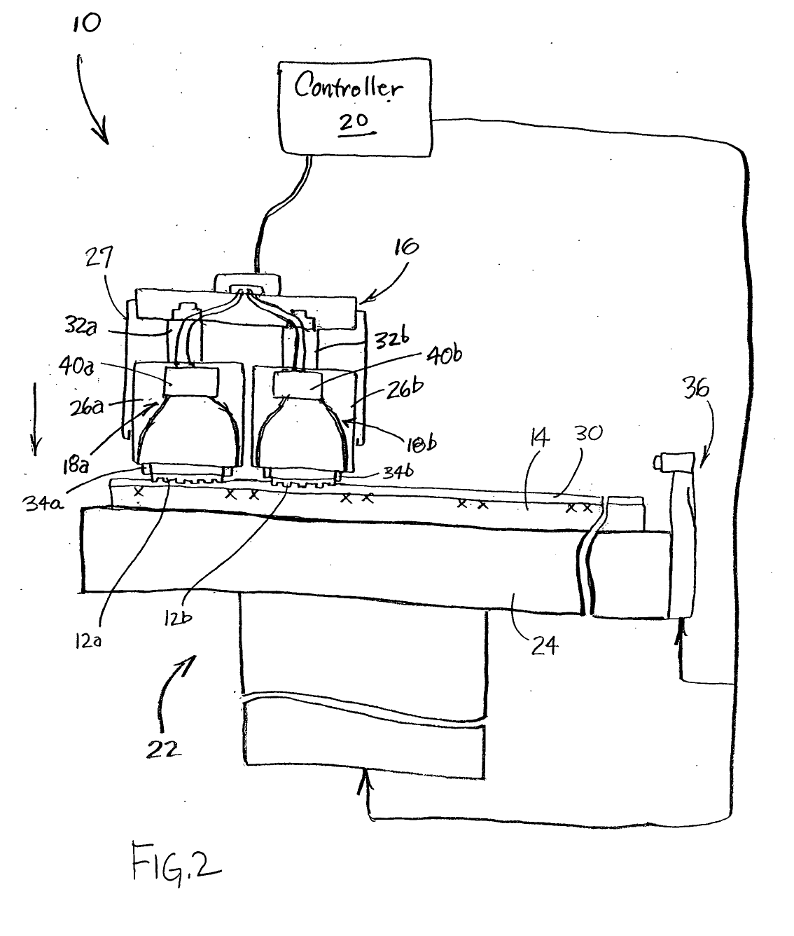

The system 10 includes a housing 27, which can be configured to at least partially enclose the heads 26a-d as a unit. FIGS. 1-2 depict details of two of the heads 26a-b; heads 26c-d are similarly structured. Each of the heads 26a-d is configured to hold a patterned template 12a-d, which includes an imprint layer 28 having a pattern of protruding features to be imprinted into a film layer 30 on the wafer 14. The templates 26a-d have a smaller area than the area of the wafer 14, and are used to form multiple imprinted Fields (F) during a step-and-repeat process to imprint a plurality of patterned Fields (F) on the wafer 14, which in the present embodiment is four Fields (F). The size of the Field (F) that is processed by each template during each step is preferably small enough to limit pattern distortions. The pattern on the templates 12a-d can be the same or different according to the processing design.

The positioning system 16 further includes an actuator mechanism 32a-d connected, respectively, to heads 12a-d. The actuator mechanisms 32a-d are configured to move the heads 26a-d precisely in an X-Y plane (axis) (indicated by arrow “A”) that is parallel to the wafer 14 on the wafer support 24, and in a Z-direction (axis, plane) (indicated by arrow “B”) that is orthogonal (perpendicular) to the surface of the wafer 14.

The positioning system 16 is configured to move each of the heads 12a-d independently along the X-Y axis and the Z-axis to align and bring the patterned templates 28 into proper contact with the film layer 30 on the surface of the wafer 14, as depicted in FIG. 2. In one embodiment, the positioning system 54 can be configured with Z-axis actuators operable to move the heads vertically, and separate X-Y actuators to move the heads horizontally, with both actuators being carried on each of the heads 12a-d.

The heads 26a-d can also include a template-adjusting mechanism 34 that is configured to move the patterned templates 12a-d toward and away from the wafer 14 as needed to adjust the mask distortion and provide fine-tuning and proper orientation alignment to the film layer 30, for example, by tilting or rotating the template. Such mechanisms are known in the art, as described, for example, in U.S. Publication Nos. 2004/0022888 and 2006/0001857. The mechanism 34 can also be configured as a programmable device that utilizes a microelectromechanical system (MEMS).

Each of the heads 12a-d are interconnected to the system controller 20, which is configured to control the operation of the positioning system 16 based upon position reference signals that are received from the alignment systems 18a-d. The system controller 20 may be, for example, a microprocessor configured to monitor the alignment process and determine whether alignment of a template with a Field (F) on the wafer has been reached, and relaying signals to the positioning system 16 and the particular head 26a-d bearing the template.

The system 10 is illustrated as also including a dispensing system 36 for delivering a curable liquid composition onto the surface of the wafer 14 to form the film layer 30. The liquid dispensing system 36 can be, for example, a piezoelectric valve, a dispenser nozzle, spray head, or other mechanism known in the art. In another embodiment, the film layer 30 can be formed on the wafer 14 at a workstation prior to the present system 10.

Correct placement of the template with respect to the substrate is important in order to achieve proper alignment of the patterned layer with previously formed layers on the substrate. Alignment techniques can be used to bring the templates 12a-d into alignment with a particular Field (F) on the wafer 14. Positioning can be accomplished by a combination of movements of the wafer stage 24 and/or the heads 26a-d in the X-Y direction or Z-direction.

In the present embodiment, signals from the alignment systems 18a-d to the system controller 20 cause the moveable stage 24 to roughly align with the templates 12a-d on the heads 26a-d, and can also cause actuation of the positioning system 16 to move each of the heads 26a-d individually to more precisely position the templates 12a-d within a respective Field (F).

The templates 12a-d and/or the wafer 14 can have one or more alignment marks, which can be used to align the templates 12a-d and the wafer 14, for example, using an optical imaging device (e.g., microscope, camera, imaging array, etc.). As depicted, the wafer 14 includes alignment marks “X” to designate the Fields (F). In the illustrated example, the alignment system 18 is an optical system that includes a sensor 38a-d, for example, a fiber optic sensor, associated with each head 26a-d to sense the alignment marks (X) on the wafer 14. Each of the sensors 38a-d is connected to a controller 40a-d having optoelectronics including a light source, photodetector, and associated signal processing electronics. The controller 40a-d is configured to transmit position reference signals to the system controller 20 based upon light received from the surface of the wafer 14 by each sensor 38a-d independently.

Alignment systems are well known in the art. For example, an alignment mark can be provided on each of the templates 26a-d and complementary marks on the wafer 14, and the sensors 38a-d can be configured to transmit a signal to the system controller 20 based on the two marks. In another optical alignment system, the sensor can be configured to detect a moire alignment pattern generated from optical alignment marks on the wafer 14. In another embodiment, the alignment marks can comprise an electrically conductive material, and the sensor can be configured to detect the capacitance between the marks. In another system, the positioning of the templates within the Fields (F) on the wafer is based upon signals received from an optical alignment system and a probe alignment system as described, for example, in U.S. Pat. No. 6,955,767, which is incorporated herein by reference.

In operation, an imprint process according to the present embodiment involves advancing the position of the wafer 14 to align a set of Fields to under the heads 26a-d by stepping (moving) the wafer stage 22 supporting the wafer along an X-Y plane and/or a Z-plane. In FIGS. 1-2, imprint heads 12a-b are shown as being aligned with adjacently positioned Fields (F), although other configurations can be achieved with the present system. The actuator mechanisms 32a-d are then actuated to respectively move the heads 12a-d along an X-Y plane and/or a Z-plane until each of the patterned templates 12 are properly positioned within a Field (F) on the wafer 22 to be imprinted (illustrated as adjacent Fields in the present embodiment). With the present system, the heads can be operated to align the templates and imprint the resist layer 30 on the wafer 14 simultaneously (i.e., in parallel).

Each of the patterned templates 12a-d is optically aligned with the respective alignment marks X on the wafer 14 based on the interaction of the sensor 38a-d with the alignment marks X. After the templates 12a-d are aligned, the templates are urged (pressed) into a moldable thin film 30 on the wafer 14 to create a pattern on the film. A typical film material is a thermoplastic polymer such as polymethylmethacrylate (PMMA), among others. The templates 12a-d are then separated from the film layer 30 by activating the actuating mechanisms 32a-d in the Z-direction. The position of the templates 12a-d is then incrementally advanced by “stepping” or moving the heads 26a-d by the actuating mechanisms 32a-d in the X-Y plane in position relevant to another set of Fields (F), being four Fields in the present embodiment, where the alignment process is repeated and the Fields are imprinted having an identical patter to the first set of Fields (F). This process may be continually repeated until the wafer 14 is patterned.

The patterned film layer 30 can then be further processed, for example, by etching to expose underlying areas of the wafer 14. A transport mechanism may be used to transport the wafer to a subsequent workstation for additional processing.

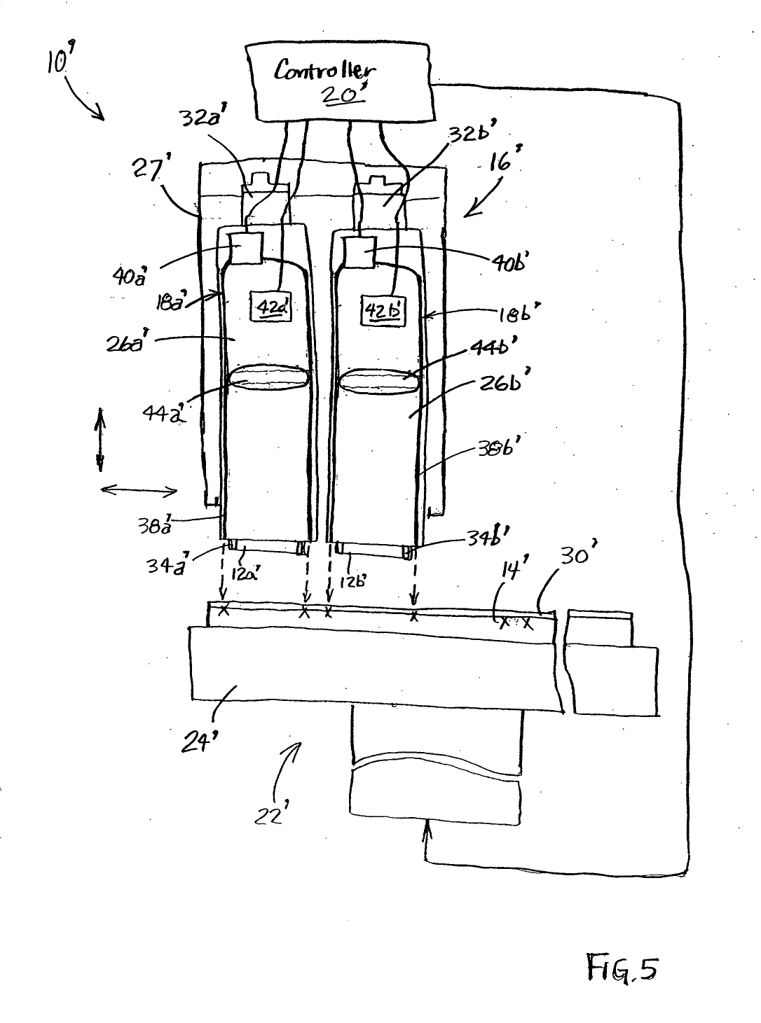

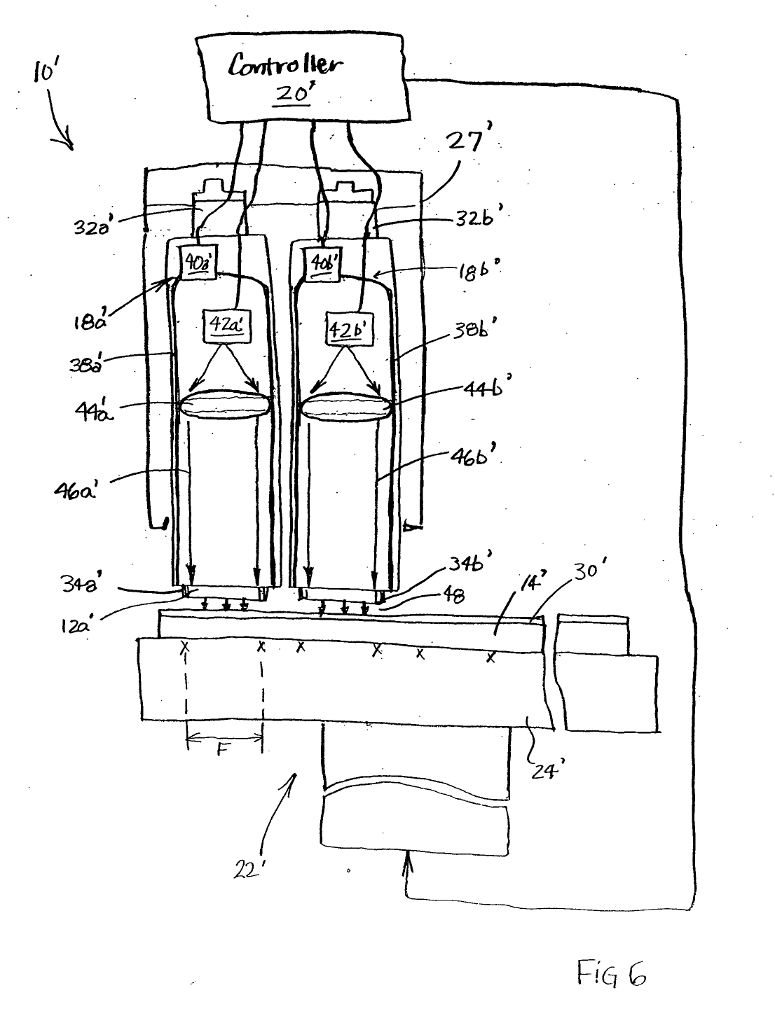

FIGS. 5-6 depict another embodiment of a system 10′ according to the invention for near-field optical lithography, in which a patterned template (i.e., photomask) is brought into close proximity but not into contact with a thin film (e.g., photoresist) on a substrate. A near-field light is projected through the template to produce an optical image of the template pattern in the photoresist layer. By performing an appropriate development process, a pattern in the photoresist layer corresponding to the image projected from the template is obtained.

Similar to the previously described system 10, the near-field lithography system 10′ generally includes a template positioning system 16′, an alignment system 18′, a system controller 20′, and a substrate (e.g., wafer) stage 22′.

The wafer stage 22′, which is moveable in this embodiment, includes a wafer support 24′ securing a wafer 14′ to be imprinted.

As illustrated, the template positioning system 16′ includes a plurality of heads26a-d′, of which two heads 26a-b′ are shown in a cross-sectional view, and will be discussed in more detailed. It is understood that the positioning system 16′ can be configured with two or more heads within certain limitations as discussed above.

Referring to FIG. 5, each head 26a-b′ holds a patterned template 12a-b′ (i.e., photomask or reticle) for near-field exposure. Exemplary near-field photomasks are described, for example, in U.S. Publ. Nos. 2006/0003236 (Mizutani) and 2004/0080732 (Kuroda), among others.

Each head 26a-b′ is configured with illumination components to provide near-field exposure, including a light source 42′ and a collimating lens 44′ to direct the exposure light 46′ toward the template. The light source 42′ is configured to generate an exposure light 46′ in a wavelength range effective to expose the resist. Exemplary light sources include mercury (Hg) and iodine (I) lamps at 365 nm, as well as laser sources, for example, that provide UV radiation (e.g., wavelengths of 248 nm, 293 nm, 157 nm), and extreme UV (EUV) (e.g., a wavelengths of about 5-20 nm), for example. The illumination system can include other types of optical components as appropriate for the exposure radiation being used for directing, shaping, or controlling the projection beam of the light 46′.

In another embodiment, a near-field apparatus 10″ can be configured for optical plasmonic lithography using surface plasmon effects to generate high density nanoscale features (e.g., sub-100 nm scale features) in the photoresist layer, by incorporating a plasmonic mask as the template 12a-b″ to manipulate the exposure light 46″emitted from the light source 42″. Plasmonic masks are described, for example, in U.S. Pub. No. 2005/0233262 (Luo et al.); Srituravanich et al., “Plasmonic Nanolithography,” Nano Letters 4(6): 1085-1088 (2004); Srituravanich et al., “Deep subwavelength nanolithography using localized surface plasmon modes on planar silver mask,” J. Vac. Sci. Technol. B 23(6):2636-2639 (2005), among others, the disclosures of which are incorporated by reference herein. Without proscribing to a particular model, an exemplary technique utilizes an appropriate excitation light source (e.g., near UV light) to excite surface plasmons on a metal substrate (e.g., aluminum) in order to enhance transmission of shorter wavelengths than the excitation light wavelength. An exemplary mask is composed of a transparent material layer (e.g., quartz) and a metal layer (e.g., aluminum, gold, silver, etc.) that is perforated with sub-wavelength hole arrays. When the illuminating light (e.g., near UV light, 365 nm wavelength) is irradiated on the plasmonic mask, the light couples with surface plasmons in the metal layer to produce surface plasmon resonance, which intensifies the strength of the near-field light illuminating the resist layer and forming nanofeatures having a dimension less than the wavelength of the light.

As shown in FIG. 5, the heads 26a-b′ of the near-field optical system 10′ are each connected to an actuator mechanism 32a-b′, which can be activated to move the heads in an X-Y plane (arrow “A”) and/or a Z-plane (arrow “B”) for alignment and proximity adjustment with respect to the wafer.

An alignment system 18a-b′ (e.g., an optical imaging device) incorporated into each head 26a-b′. Utilizing the alignment system 18a-b′, and reference or alignment marks (X) that are typically on the wafer 14′ (as shown), the wafer stage 22′ is moved along an X-Y plane (arrow “A”) to provide relative alignment of the wafer 14′ with the photomask templates 12a-b′. As shown, each alignment system 18a-b′ includes a sensor 38a-b′ connected to a controller 40a-b′ with associated optoelectronics, which is in turn connected to the system controller 20′ for transmission of signals corresponding to the position of the sensors relative to the reference marks (X). Based on signals from the alignment system, the controller 20′ can direct the movement of the wafer stage 22′ and/or each head 26a-b′ individually in a X-Y plane and/or a Z-plane to further align the photomask templates 12a-b′ relative to the Field (F) to be imprinted.

The wafer stage 22′ and/or the template positioning system 16′ can be moved in a Z-direction to bring the photomask templates 12a-b′ into close proximity to the photoresist layer 30′ on the wafer 14′ up to a distance within a near-field region defining a space or gap 48′ therebetween. Typically, the gap 48′ provides a surface clearance of about 50 nm, and typically about 100 nm or less over the exposure region (Field, F). The heads 26a-b′ can be individually adjusted utilizing the actuator mechanism 32a-b′ to alter the gap 48′ as needed, and to further align the templates 12a-b′ with the respective Fields (F). The heads 26a-d can also include a template-adjusting mechanism 34′ configured to adjust the distortion of the mask by altering the orientation of the templates 12a-b′ with respect to the film layer 30′, which can be a MEMS device.

Thereafter, the exposure light 46′ is emitted from the light source 42′, transformed by the collimating lens 44′ into parallel light, and projected onto the backside of the photomask template 12a-b′. The light is illuminated to the photoresist layer 30′ through the photomask template 12a-b′ whereby a near field is produced at the front side of the photomask to expose the resist film layer. The near-field photomask template 12a-b′ is a size smaller than the substrate 14′, and the near-field exposure for a part of the substrate is repeated while changing the exposure position on the substrate.

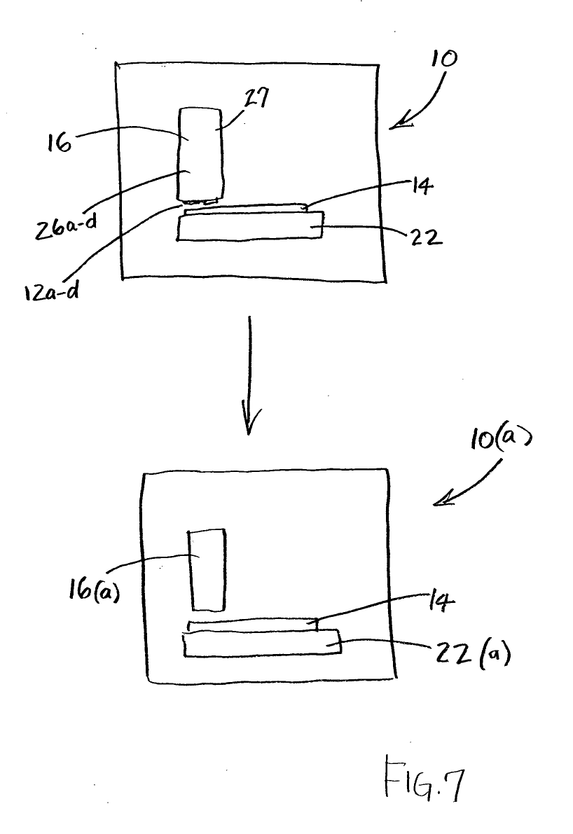

Referring now to FIG. 7, in a further embodiment, multiple stages can be used to imprint all or nearly all of the surface of a wafer or other surface. For example, system 10 described and illustrated with reference to FIGS. 1-4, can be employed to imprint a wafer 14 utilizing the wafer stage 22 and templates 12a-d of heads 26a-d within the template positioning system 16 of system 10. The wafer 14 can then be transported (arrow) to another system 10(a) with a stage 22(a) having a template positioning system 16(a) with a different configuration of heads to complete the patterning of the wafer surface, or to imprint the wafer with an additional pattern.

The apparatus and methods of the present invention can be utilized in various semiconductor device fabrications including, for example, integrated circuits used for storing or processing digital information such as Dynamic Random Access Memory (DRAM), Static Random Access Memory (SRAM), Synchronous Graphics Random Access Memory (SGRAM), Programmable Read-Only Memory (PROM), Electrically Erasable PROM (EEPROM), flash memory dice, and microprocessor dice.

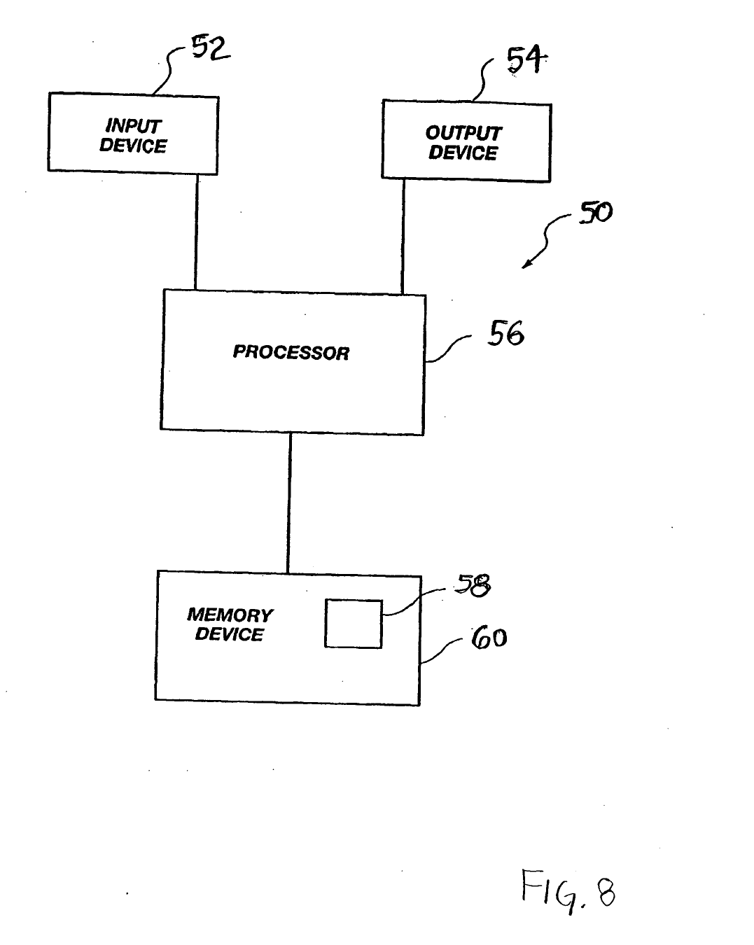

The wafer 14 can incorporates a plurality of integrated circuit devices formed utilizing the invention. As shown in FIG. 8, an electronic system 50 can includes an input device 52 and an output device 54 coupled to a processor 56 incorporating a memory device 58 that includes an integrated circuit device 60 formed according to the invention.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents. The disclosures of the cited patents, published applications, and references are hereby incorporated by reference herein.

What is claimed is:

1. A lithographic system for forming a pattern on a substrate, comprising:
a template positioning system comprising a housing coupled to a plurality of imprint heads, each head configured to hold a patterned template;
the system configured for positioning the templates in parallel in proximity to the substrate.

2. The system of claim 1, wherein the heads and the templates are configured for imprint lithography.

3. The system of claim 1, wherein the heads and the templates are configured for near-field optical lithography.

4. The system of claim 3, wherein the templates are configured for generating surface plasmons.

5. The system of claim 1, wherein each head further comprises an actuator mechanism coupled thereto, the actuator mechanism configured to move the head in an X-Y plane, a Z-plane, or both.

6. The system of claim 1, wherein each head further comprises an alignment device coupled thereto being operable for aligning the template to the substrate.

7. The system of claim 1, wherein each head further comprises a template-adjusting mechanism operable to alter the template orientation to the substrate.

8. An imprint lithographic system for forming a pattern on a substrate, comprising:
a template positioning system comprising a housing containing a plurality of imprint heads, each head configured to hold a patterned template; and each head comprising:
an actuator mechanism coupled thereto, the actuator mechanism configured to move the head in an X-Y plane, a Z-plane, or both;
an alignment device coupled thereto being operable for aligning the template to the substrate; and
a template-adjusting mechanism operable to alter the template orientation to the substrate;
the lithographic system configured for applying the templates in parallel to the substrate.

9. An near-field optical lithographic system for forming a pattern on a substrate, comprising:
a template positioning system comprising a housing containing a plurality of imprint heads, each head configured to hold a photomask template; and each head comprising radiation illuminating components for generating radiation through the photomask template;
the lithographic system configured for positioning the photomask templates in parallel proximal to the substrate.

10. The system of claim 9, wherein the radiation illuminating components comprise a light source, a collimating lens, or a combination thereof.

11. The system of claim 9, wherein each head further comprises a mechanism coupled thereto and selected from the group consisting of:
an actuator mechanism configured to move the head in an X-Y plane, a Z-plane, or both;
an alignment mechanism operable for aligning the template to the substrate; and
a template-adjusting mechanism operable to alter the template orientation to the substrate.

12. The system of claim 9, wherein the photomask template is configured to generate surface plasmons.

13. A lithographic system for forming a pattern on a substrate, comprising:
a wafer stage configured to support the substrate and move the substrate in an X-Y plane, a Z-plane, or both;
a template positioning system comprising a housing coupled to a plurality of imprint heads, each head configured to hold a patterned template; each head comprising an alignment device coupled thereto being operable for aligning the template to the substrate; and
a system controller coupled to and configured for actuating the template positioning system, alignment system, and wafer stage, to position the templates in parallel in proximity to the substrate.

14. The system of claim 13, wherein each head further comprises an actuator mechanism configured to move the head in an X-Y plane, a Z-plane, or both.

15. The system of claim 13, further comprising a liquid dispenser configured to dispense a curable liquid onto the substrate situated on the wafer stage.

16. A lithographic method of forming a pattern on a substrate comprising a plurality of defined fields, comprising:
aligning a template positioning system relative to the substrate, the template positioning system comprising a housing coupled to a plurality of imprint heads, each head configured to hold a patterned template; each template being aligned within a different field on the substrate; and
patterning said fields utilizing each of said templates in parallel.

17. The method of claim 16, wherein each head comprises an alignment device coupled thereto, and the method further comprises activating the alignment devices to align the templates within each of said fields.

18. The method of claim 16, wherein each head further comprises an actuator mechanism coupled thereto, and the method further comprises actuating one or more of the actuator mechanisms to move the head coupled thereto in an X-Y plane, a Z-plane, or both.

19. The method of claim 16, wherein each head further comprises a template-adjusting mechanism, and the method further comprises actuating one or more of said mechanisms to alter an orientation of the template coupled thereto to the substrate.

20. A method of forming a pattern on a substrate comprising a plurality of defined fields, comprising:
aligning a template positioning system relative to the substrate, the template positioning system comprising a housing coupled to a plurality of imprint heads, each head configured to hold a template having a pattern situated thereon; each template being aligned within a different field of said plurality of fields on the substrate; and
contacting the substrate with each of said templates to pattern said plurality of fields about concurrently.

21. A method of patterning a substrate comprising a plurality of defined fields, comprising:
aligning a template positioning system relative to the substrate, the template positioning system comprising a housing coupled to a plurality of imprint heads, each head configured to hold a photomask template defining a pattern; each head comprising a radiation illuminating system for providing radiation through the photomask template; each photomask template being aligned within a different field of said plurality of fields on the substrate and positioned in proximity to the substrate with a gap therebetween; and
activating the radiation illuminating systems of each of the heads to generate radiation through each of the photomask templates to pattern said plurality of fields about concurrently.

22. The method of claim 21, wherein the radiation illuminating system comprises a light source, a collimating lens, or a combination thereof.

23. A method of patterning a substrate comprising a plurality of defined fields, comprising:
providing an apparatus comprising:
a wafer stage configured to support the substrate and move the substrate in an X-Y plane, a Z-plane, or both;
a template positioning system comprising a housing coupled to a plurality of imprint heads, each head configured to hold a patterned template; each head comprising an alignment device coupled thereto being operable for aligning the template to the substrate; and
a system controller coupled to and configured for actuating the template positioning system, alignment system, and wafer stage, to position the templates in parallel in proximity to the substrate;
moving the wafer stage to align the substrate relative to the templates such that each template is aligned within a different field of said plurality of fields on the substrate;
patterning said fields about concurrently utilizing each of said templates in parallel.

24. The method of claim 23, wherein the step of patterning comprises contacting the substrate with the templates to imprint a pattern thereon.

25. The method of claim 23, wherein each head comprises a radiation illuminating system for generating radiation through the template, and the step of patterning comprises activating the radiation illuminating systems of each of the heads to generate radiation through each of the photomask templates to pattern said plurality of fields about concurrently.

26. The method of claim 25, wherein each of the templates is configured for generating surface plasmons.

27. The method of claim 23, wherein each head further comprises an actuator mechanism coupled thereto, and the method further comprises the step of actuating one or more of said actuator mechanisms to move the head coupled thereto in an X-Y plane, a Z-plane, or both to further align the template within the defined field.

28. The method of claim 23, wherein each head further comprises a template-adjusting mechanism, and the method further comprises actuating one or more of said mechanisms to alter an orientation of the template coupled thereto to the substrate.

29. The method of claim 23, wherein the apparatus further comprises a liquid dispenser coupled thereto, and the method further comprises, prior to patterning the substrate, dispensing a curable liquid to form the substrate layer over a supporting substrate.

30. The method of claim 29, wherein the supporting substrate comprises a semiconductor wafer.

31. The method of claim 23, further comprising:
moving the wafer stage to realign the substrate relative to the template positioning system such that the templates are aligned with a non-patterned set of a plurality of fields on the substrate, and each template is aligned within a different field of said plurality of fields; and
patterning said plurality of fields about concurrently utilizing each of said templates in parallel.

32. The method of claim 31, further comprising repeating the steps of moving the wafer stage and patterning to pattern the substrate.

33. A lithographic imprint head apparatus, comprising
a plurality of imprint heads coupled to a common housing as a unit, each head configured to hold a patterned template; and each head comprising a device coupled thereto and selected from the group consisting of:
an actuator device configured to move the head in an X-Y plane, a Z-plane, or both;
an alignment device operable for aligning the template to a substrate; and
a template-adjusting device operable to alter the template orientation to the substrate.

34. The apparatus of claim 33, wherein the heads and the templates are configured for imprint lithography.

35. The apparatus of claim 33, wherein the heads and the templates are configured for near-field optical lithography.

36. The apparatus of claim 35, wherein the templates are configured for generating surface plasmons.

37. The apparatus of claim 35, wherein each head comprising radiation-illuminating components for generating radiation through the photomask template.

38. The apparatus of claim 37, wherein each head comprises a light source, a collimating lens, or a combination thereof.
